(19) United States
(12) Patent Application Publication
(10) Pub. No.: US 2009/0066706 A1
(43) Pub. Date: Mar. 12, 2009

(54) Image Processing System

(75) Inventors: Masahiro Yasue, Kanagawa (JP); Eiji Iwata, Kanagawa (JP); Munetaka Tsuda, Tokyo (JP); Ryuji Yamamoto, Tokyo (JP); Shigeru Enomoto, Kanagawa (JP); Hiroyuki Nagai, Tokyo (JP)

Correspondence Address: GIBSON & DERNIER L.L.P., 900 ROUTE 9 NORTH, SUITE 504, WOODBRIDGE, NJ, 07095, US

(73) Assignee: SONY COMPUTER ENTERTAINMENT INC., Tokyo (JP)

(21) Appl. No.: 11/912,703

(22) PCT Filed: Apr. 6, 2006
(86) PCT No.: PCT/JP2006/307322

§ 371 Date: Jan. 2, 2008

(30) Foreign Application Priority Data
May 13, 2005 (JP) 2005-141353

(51) Int. Cl. G06F 15/80

(52) U.S. Cl. 345/505

(57) ABSTRACT

The present multi-processor system performs information processing suitably. The system can receive, reproduce and record a variety of image contents. By comprising a powerful CPU in the multi-processors, a plurality of pieces of large image data, such as high definition image data or the like, can be processed simultaneously in parallel, which was difficult conventionally. Since task processing, such as demodulation processing or the like, is assigned respectively in view of the remaining processing capacity of each of the plurality of processors, the system can reproduce contents efficiently. By sharing roles, a plurality of different contents, such as an image, a voice, or the like can be processed simultaneously and can be displayed or reproduced at a desired timing.

### BACKGROUND

The present invention generally relates to information processing technology using multi-processors, and more particularly to an image processing system for performing image processing in a multi-processor system.

In recent years, there has been significant development in computer graphics technology and image processing technology, used in the field of computer games, digital broadcasting or the like. Along with the developments, information processing apparatuses, such as computers, gaming devices, televisions or the like are required to be able to process higher resolution image data at higher speed. To implement high performance arithmetic processing in these information processing apparatuses, a parallel processing method can be effectively utilized. With the method, a plurality of tasks are processed in parallel by allocating the tasks to respective processors in an information processing apparatus provided with a plurality of processors. To allow a plurality of processors to execute a plurality of tasks in coordination among each other, it is necessary to allocate tasks efficiently depending on the state of respective processors.

However, it is generally difficult for a plurality of processors to execute tasks efficiently in parallel when processing a plurality of contents.

In this background, a general purpose of the present invention is to provide an image processing apparatus which can process a plurality of contents more efficiently.

### SUMMARY OF THE INVENTION

According to one embodiment of the present invention, an image processing system is provided. The image processing system comprises: a plurality of sub-processors operative to process data on image in a predetermined manner; a main-processor, connected to the plurality of sub-processors via a bus, operative to execute a predetermined application software and to control the plurality of sub-processors; a data providing unit operative to provide the data on image for the main-processor and the plurality of sub-processors via the bus; and a display controller operative to perform processing for outputting an image processed by the plurality of sub-processors to a display apparatus, wherein the application software is described so as to include information indicating respective roles assigned to the respective plurality of sub-processors and information indicating the display position of respective images processed by the plurality of sub-processors on the display apparatus and the display effect of the images; and according to the information indicating respective roles assigned by the application software and information indicating the display effect, the plurality of sub-processors sequentially process the data on the image provided from the data providing unit and display the processed image at the display position on the display apparatus.

Implementations of the invention in the form of methods, apparatuses, systems, recording mediums and computer programs may also be practiced as additional modes of the present invention.

According to the present invention, the image processing with multi-processors can be performed properly.

### BRIEF DESCRIPTION OF THE DRAWINGS

FIG. 1 shows an exemplary configuration of an image processing system according to the present embodiment.

FIG. 2 shows an exemplary configuration of the main-processor shown in FIG. 1.

FIG. 3 shows an exemplary configuration of the sub-processor shown in FIG. 1.

FIG. 4 shows an exemplary configuration of application software stored in the main memory shown in FIG. 1.

FIG. 5 shows an example of a first display screen image on the display unit shown in FIG. 1.

FIG. 6 shows an example of sharing of roles among the sub-processors 12 shown in FIG. 1.

FIG. 7 shows an example of an entire processing sequence according to an embodiment of the present invention.

FIG. 8 shows an example of the starting sequence shown in FIG. 7.

FIG. 9 shows an example of a first processing sequence in the signal processing sequence shown in FIG. 7.

FIG. 10 shows an example of a second processing sequence in the signal processing sequence shown in FIG. 7.

FIG. 11 shows an example of a third processing sequence in the signal processing sequence shown in FIG. 7.

FIG. 12 shows an example of a fourth processing sequence in the signal processing sequence shown in FIG. 7.

FIG. 13 shows an exemplary configuration of the main memory shown in FIG. 1.

FIG. 14A shows an example of a second display screen image on the displaying unit shown in FIG. 1.

FIG. 14B shows an example of a third display screen image on the displaying unit shown in FIG. 1.

FIG. 14C shows an example of a fourth display screen image on the displaying unit shown in FIG. 1.

FIG. 15A shows a photograph of an intermediate screen image which is an example of a fifth screen image displayed on the displaying unit shown in FIG. 1.

FIG. 15B shows a photograph of an intermediate screen image which is an example of a sixth screen image displayed on the displaying unit shown in FIG. 1.

FIG. 15C shows a photograph of an intermediate screen image which is an example of a seventh screen image displayed on the displaying unit shown in FIG. 1.

FIG. 15D shows a photograph of an intermediate screen image which is an example of a eighth screen image displayed on the displaying unit shown in FIG. 1.

### DETAILED DESCRIPTION OF THE INVENTION

Before specifically explaining an embodiment according to the present invention, an outline of an image processing system according to the present embodiment will be described initially. The image processing system according to the present embodiment comprises multi-processors which include a main-processor and a plurality of sub-processors, a television tuner (herein after referred to as a “TV tuner”), a network interface, a hard disk, a digital video disk driver (herein after referred to as a “DVD driver”), or the like. The system can receive, reproduce and record a variety of image contents. By comprising a powerful CPU in the multi-processors, a plurality of pieces of large image data, such as high definition image data or the like, can be processed simultaneously in parallel, which was difficult conventionally. Since task processing, such as demodulation processing or the like, is assigned respectively in view of the remaining processing capacity of each of the plurality of processors, the system can reproduce contents efficiently. By sharing roles, a plurality of different contents, such as an image, a voice, or the like can be processed simultaneously and can be displayed or reproduced at a desired timing. Image data, processed by defining a display effect and a display position in advance, can be displayed on a display or the like as an image easily recognizable visually and reproduced as a voice easily recognizable aurally. A detailed description will be given later.

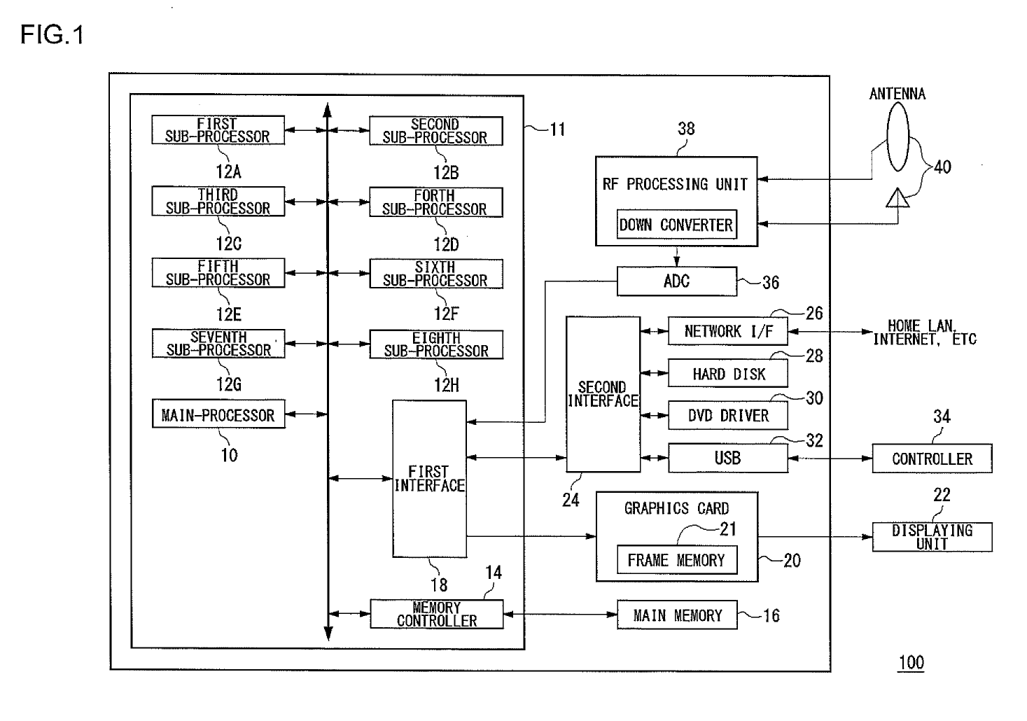

FIG. 1 shows an exemplary configuration of an image processing system 100 according to the present embodiment. The image processing system 100 includes a main-processor 10, a first sub-processor 12A, a second sub-processor 12B, a third sub-processor 12C, a forth sub-processor 12D, a fifth sub-processor 12E, a sixth sub-processor 12F, a seventh sub-processor 12G, a eighth sub-processor 12H, the sub-processors 12 being represented by “sub-processor 12”, a memory controller 14, a main memory 16, a first interface 18, a graphics card 20, a displaying unit 22, a second interface 24, a network interface 26 (hereinafter also referred to as a “network IF 26”), a hard disk 28, a DVD driver 30, a universal serial bus 32 (hereinafter referred to as a “USB 32”), a controller 34, an analog digital converter 36 (hereinafter referred to as an “ADC 36”), a radio frequency processing unit 38 (hereinafter referred to as a “RF processing unit 38”) and an antenna 40.

The image processing system 100 comprises a multi-core processor 11 as a central processing unit (hereinafter referred to as a “CPU”). The multi-core processor 11 comprises the one main-processor 10, the plurality of sub-processors 12, the memory controller 14 and the first interface 18. A configuration with eight sub-processors 12 is shown in FIG. 1 as an example. The main-processor 10 is connected with the plurality of sub-processors 12 via a bus, manages scheduling of the execution of threads in respective sub-processors 12 according to an after-mentioned application software 54 and manages the multi-core processor 11 generally. The sub-processor 12 processes data on image transmitted from the memory controller 14 via the bus, in a predetermined manner. The memory controller 14 performs reading and writing process on data or the application software 54 stored in the main memory 16. The first interface 18 receives data transmitted from the ADC 36, the second interface 24 or the graphics card 20 and outputs the data to the bus.

The graphics card 20, which is a display controller, works on the image data, transmitted via the first interface 18, based on the display position and the display effect of the image data and transmits the data to the displaying unit 22. The displaying unit 22 displays the transmitted image data on a display apparatus, such as a display or the like. The graphics card 20 may further transmit data on sound and volume of sound to a speaker (not shown) according to an instruction from the sub-processor 12. Further, the graphics card 20 may include a frame memory 21. In this case, the multi-core processor 11 can display an arbitrary moving image or static image on the displaying unit 22 by writing the image data into the frame memory 21. The display position of an image on the displaying unit 22 is determined according to an address, where the image is written, in the frame memory 21.

The second interface 24 is an interface unit interfacing the multi-core processor 11 and a variety of types of devices. The variety of types of devices represent a home local area network (hereinafter referred to as a “home LAN”), the network interface 26 which is an interface for the internet or the like, the hard disk 28, the DVD driver 30, the USB 32 or the like. The USB 32 is an input/output terminal for connecting with the controller 34 which receives an external instruction from a user.

The antenna 40 receives TV broadcasting wave. The TV broadcasting wave may be analogue terrestrial wave, digital terrestrial wave, satellite broadcasting wave or the like. The TV broadcasting wave may also be high-definition broadcasting wave. The TV broadcasting wave may include a plurality of channels. The TV broadcasting wave is down-converted by a down converter included in the RF processing unit 38 and is converted from analogue to digital by the ADC 36, accordingly. Thus, digital TV broadcasting wave which has been down-converted and includes a plurality of channels is input into the multi-core processor 11.

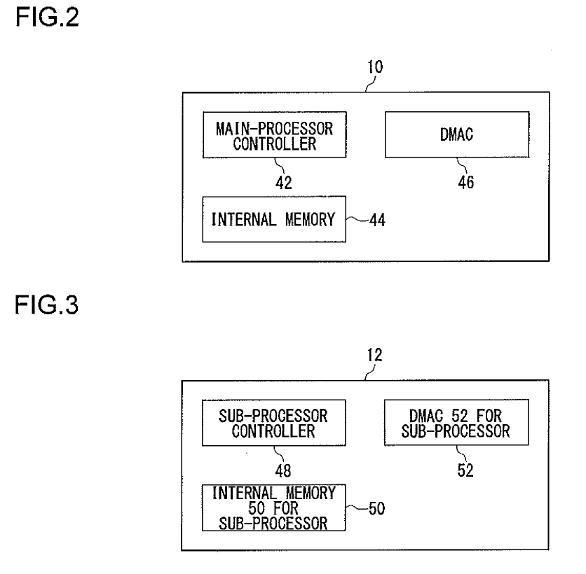

FIG. 2 shows an exemplary configuration of the main-processor 10 shown in FIG. 1. The main-processor 10 includes a main-processor controller 42, an internal memory 44 and a direct memory access controller 46 (hereinafter referred to as a “DMAC 46”). The main-processor controller 42 controls the multi-core processor 11 based on the application software 54 read out from the main memory 16 via the bus. More specifically, the main-processor controller 42 instructs respective sub-processors 12 about image data to be processed and a processing procedure. A detailed description will be given later. The internal memory 44 is used to retain intermediate data temporarily when the main-processor controller 42 performs processing. By using the internal memory 44 while not using an external memory, reading and writing operations can be performed in high speed. The DMAC 46 transmits data to/from respective sub-processors 12 or the main memory 16 at high speed using a DMA method. The DMA method refers to a function with which data can be transmitted directly between the main memory 16 and co-located devices or among the co-located devices while bypassing a CPU. In this case, a large amount of data can be transmitted at high speed since the CPU is not burdened.

FIG. 3 shows an exemplary configuration of the sub-processor 12 shown in FIG. 1. The sub-processor 12 includes a sub-processor controller 48, an internal memory 50 for sub-processor and a direct memory access controller 52 for sub-processor (hereinafter referred to as a “DMAC 52”). The sub-processor controller 48 executes threads in parallel and independently, in accordance with the control of main-processor 10, and processes data. A thread represents a plurality of programs, an executing procedure of the plurality of programs, control data necessary to execute the programs and/or the like. The threads may be configured so that a thread in the main-processor 10 and a thread in the sub-processor 12 operate in coordination. The internal memory 50 is used to retain intermediate data temporarily when the data is processed in the sub-processor 12. The DMAC 52 transmits data to/from the main-processor 10, another sub-processor 12 or the main memory 16 at high speed while using the DMA method.

The sub-processor 12 performs process which is assigned to the processor depending on respective processing capacity or remaining processing capacity. In an after-mentioned example, explanations are given on the assumption that all the sub-processors 12 have a same amount of processing capacity and do not perform other processes than the processes shown in the examples. The “processing capacity” represents the size of data, the size of program or the like which can be processed by the sub-processor 12 substantially simultaneously. In this case, the size of display screen image determines the number of processes which can be processed per sub-processor 12. In the after-mentioned example, it is assumed that each sub-processor 12 can perform two frames of MPEG decoding processes. If the display screen image is smaller, more than or equal to two frames of MPEG decoding processes can be performed per sub-processor. If the size of display screen image become larger, only one frame of MPEG decoding process can be performed. One frame of MPEG decoding process may be shared by a plurality of sub-processors 12.

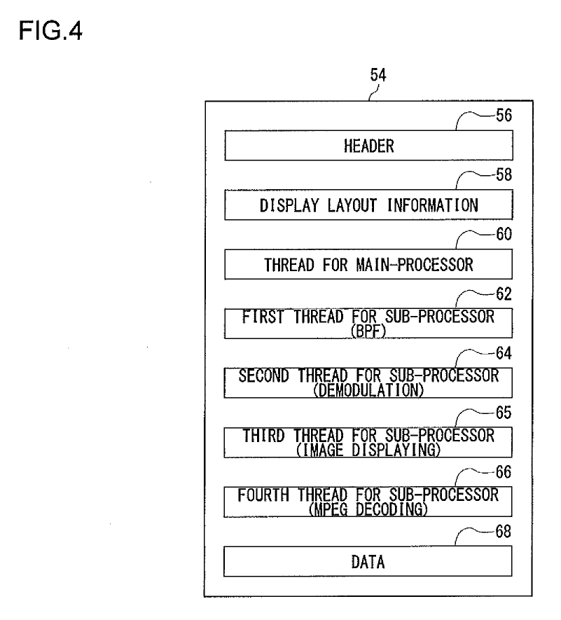

FIG. 4 shows an exemplary configuration of the application software 54 stored in the main memory 16 shown in FIG. 1. The application software 54 is programmed so that the main-processor 10 operates precisely in coordination with each of the sub-processors 12. A configuration of an application software for image processing, according to the present embodiment, is shown in FIG. 4. However, an application software for other utilities is also configured in a similar manner. The application software 54 is configured to include units for a header 56, display layout information 58, a thread 60 for main-processor, a first thread 62 for sub-processor, a second thread 64 for sub-processor, a third thread 65 for sub-processor, a fourth thread 66 for sub-processor and data 68, respectively. When the power is turned off, the application software 54 is stored in a non-volatile memory, such as the hard disk 28 or the like. When the power is turned on, the application software 54 is read out and loaded into the main memory 16. Then, a necessary unit is downloaded to the main-processor 10 or to the respective sub-processors 12 in the multi-core processor 11 if needed, and the unit is executed, accordingly.

The header 56 includes the number of the sub-processors 12, capacity of the main memory 16 or the like required to execute the application software 54. The display layout information 58 includes coordinate data indicating a display position when the application software 54 is executed and an image is displayed on the displaying unit 22, a display effect when displayed on the displaying unit 22, or the like.

The display effect represents here:

an effect where voice is reproduced along with an image when the image is displayed on the displaying unit 22,

an effect where image/sound changes with the elapse of time,

an effect where image/voice changes, an image is emphasized, the sound volume changes or the color strength of the image changes based on the instruction of the user through the controller 34, or the like.

“the color strength of the image changes” represents that the density or the brightness of the color of the image changes or the image blinks, or the like. These display effect are implemented by allowing the sub-processor 12 to refer to the display layout information 58 and to write the image, to which a predefined process is applied, into the frame memory 21.

As an example, it is assumed that an address A0 in the frame memory 21 corresponds to a coordinate (x0, y0) on the display screen image of the displaying unit 22 and an address A1 corresponds to a coordinate (x1, y1) on the display screen image of the displaying unit 22. When a certain image is written on A0 at time t0 and is written on A1 at time t1, the image is displayed at the coordinate (x0, y0) at time t0 and the image is displayed at the coordinate (x1, y1) at time t1, on the display unit 22. In other words, an effect can be given to a user, who is watching the screen, as if the image moved on the screen from time t0 to time t1. These effects are achieved by allowing the sub-processor 12 to process image according to the display effect defined in the after-mentioned application software 54 and to write the processed image into the frame memory 21 sequentially. This makes it possible to display an arbitrary moving image or a static image at an arbitrary position on the displaying unit 22. Further, an effect as if the image moves can be produced.

The thread 60 is a thread executed in the main-processor 10 and includes role assignment information, indicating which processing is to be processed in which sub-processor 12, or the like. The first thread 62 is a thread for performing band pass filter process in the sub-processor 12. The second thread 64 is a thread for performing demodulation process in the sub-processor 12. The fourth thread 66 is a thread for processing MPEG decoding in the sub-processor 12. The data 68 is a variety of types of data required when the application software 54 is executed.

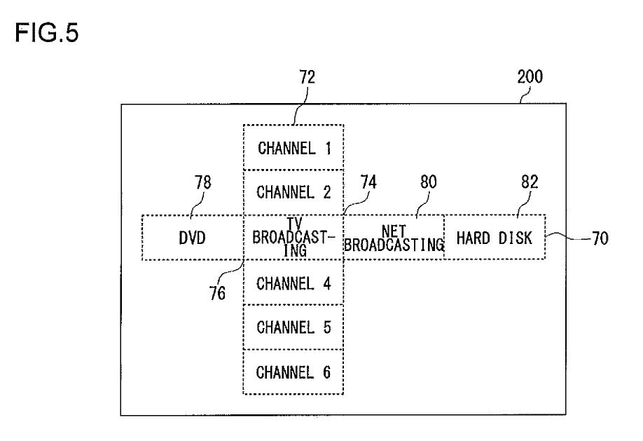

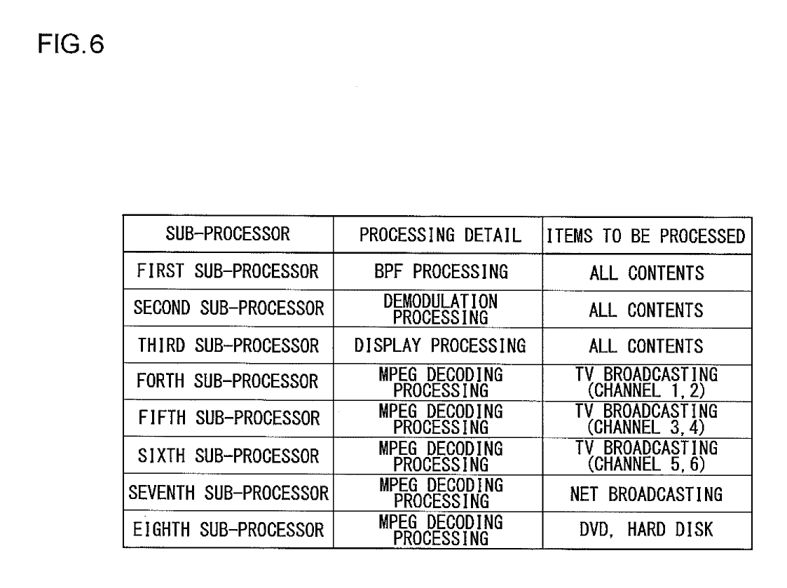

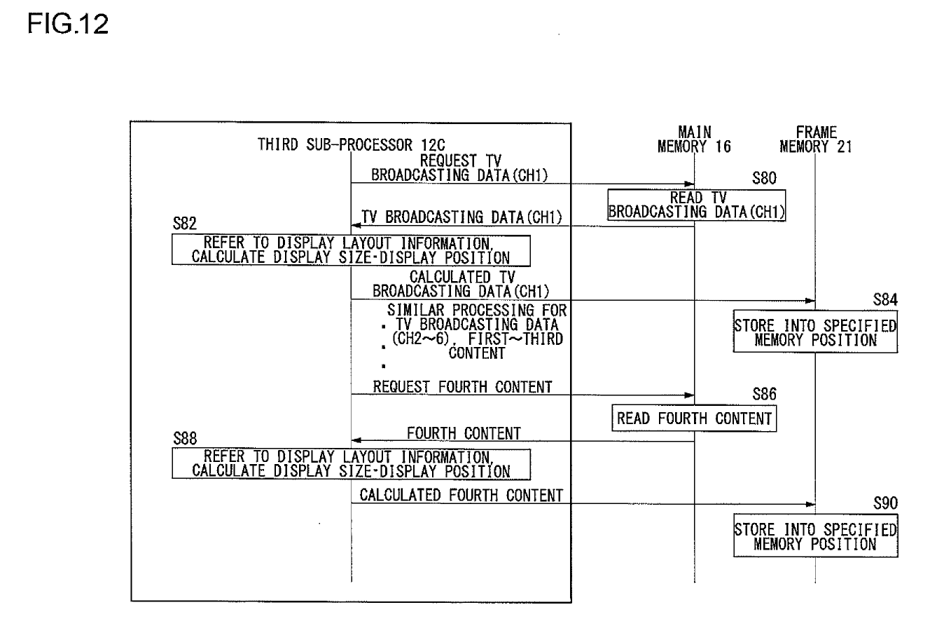

For the case of displaying the images of a plurality of contents shown in FIG. 5 on the displaying unit 22, an operational sequence for each apparatus shown in FIG. 1 will be explained below by way of FIG. 6˜FIG. 13. An explanation is given here for the case where six channels of TV broadcasting (a first content), two channels of net broadcasting (a second content), a third content stored in the hard disk 28 and a fourth content stored in a DVD in the DVD driver 30 are to be displayed, as an example.

FIG. 5 shows an example of a first display screen image on the displaying unit 22 shown in FIG. 1. FIG. 5 shows a configuration of a menu screen generated by a multi-media-reproduction apparatus. In the display screen image 200, is displayed an cross-shaped two-dimensional array consisting of a media icon array 70, in which a plurality of media icons are lined up horizontally, and a content icon array 72, in which a plurality of content icons are lined up vertically, crossed with each other. The media icon array 70 includes a TV broadcasting icon 74, a DVD icon 78, a net broadcasting icon 80 and a hard disk icon 82 as markings indicating the types of media which can be reproduced by the image processing system 100. The content icon array 72 includes icons such as thumbnails of a plurality of contents stored in the main memory 16 or the like. The menu screen configured with the media icon array 70 and the content icon array 72 is an on-screen display and superposed in front of a content image. In case that the content image which is being played is displayed as the TV broadcasting icon 74, a certain effect processing may be applied, e.g., the entire media icon array 70 and content icon array 72 may be colored to be easily distinguished from the TV broadcasting icon 74. Alternatively, the lightness of the content image may be adjusted to be easily distinguished. For example, the brightness or the contrast of the content image for the TV broadcasting icon 74 may be set higher than other contents.

A media icon, shown as the TV broadcasting icon 74 and positioned at the cross section of the media icon array 70 and the content icon array 72, may be displayed larger in different color from other media icons. An intersection 76 is placed approximately in the center of the display screen image 200 and remains in its position, while the entire array of media icons moves from side to side according to an instruction from the user via the controller 34 and the color and the size of a media icon placed at the intersection 76 changes, accordingly. Therefore, the user can select a media by just indicating the direction in left or right. Thus, determining operation, such as the clicking of a mouse generally adopted by personal computers, has become unnecessary.

FIG. 6 shows an example of sharing of roles among the sub-processors 12 shown in FIG. 1. Processing details and to-be-processed items for respective sub-processors 12 are different as shown in FIG. 6. The first sub-processor 12A performs a band pass filtering process (hereinafter referred to as a “BPF process”) on digital signals of all the contents, sequentially. The second sub-processor 12B performs a demodulation process on BPF-processed digital signals. The third sub-processor 12C reads respective image data, stored in the main memory 16 as RGB data for which the BPF process, the demodulation process and the MPEG decoding process have been completed, then calculates the display size and the display position for respective images by referring to the display layout information and writes the size and the position into the frame memory 21, accordingly. The forth sub-processor 12D˜the eighth sub-processor 12H perform MPEG decoding process on two contents given to the respective processors. The MPEG decoding process may include conversion of color formats. The color formats are, for example:

a YUV format which expresses a color with three information components, luminance (Y), subtraction of the luminance from the blue signal (U) and subtraction of the luminance from the red signal (V),

an RGB format which expresses a color with three information components, red signal (R), green signal (G) and blue signal (B) or the like.

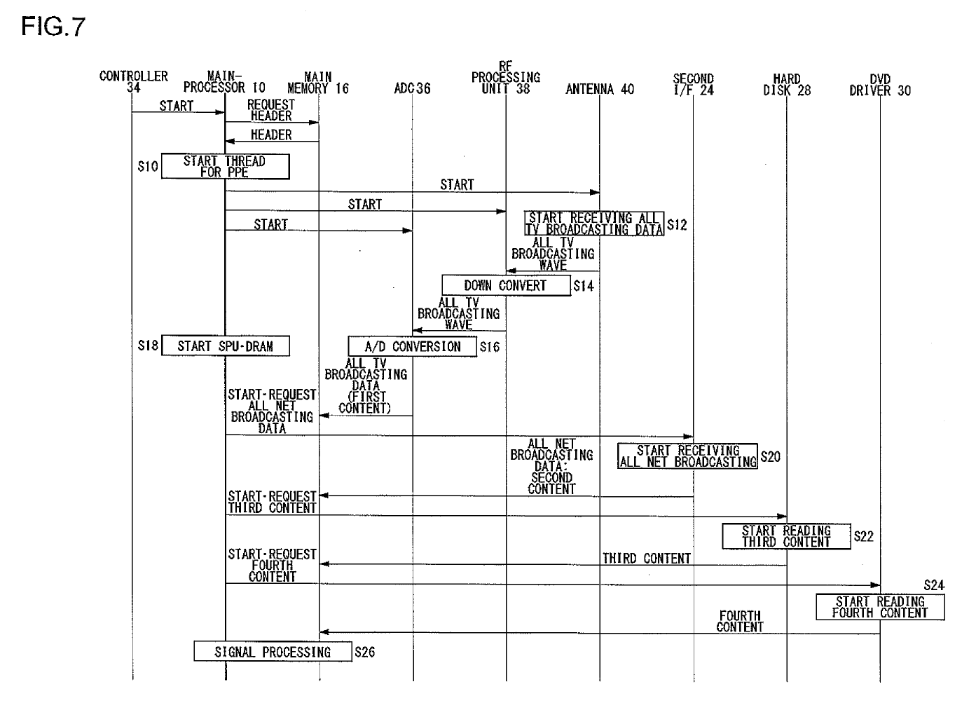

FIG. 7 shows an example of an entire processing sequence according to the present embodiment. Initially, the main-processor 10 is started by a user's instruction via the controller 34. Then the main-processor 10 requests the transmission of the header 56 from the main memory 16. After receiving the header 56, the main-processor 10 starts a thread for the main-processor 10 (S10). More specifically, the main-processor 10 transmits instructions to start: receiving TV broadcasting by the antenna 40, down-conversion processing by the down converter included in the RF processing unit 38, analogue-to-digital conversion processing by the ADC 36 or the like. Further, the main-processor 10 secures the necessary number of sub-processors 12 and the necessary capacity of memory area in the main memory 16 to execute the application, the necessary number and capacity being written in the header. For example, when flags, such as 0: unused, 1: in use and 2: reserved, are set in respective sub-processors 12 and the respective areas in the main memory 16, the main-processor 10 secures a multi-core processor 11 and a memory area in the main memory 16 in an amount required for processing, by searching for a sub-processor 12 and an area of the main memory 16 of which the flags indicate 0 and by changing the values of the flags to 2. When the necessary amount can not be secured, the main-processor 10 notifies the user via the displaying unit 22 or the like that the application can not be executed.

Subsequently, the antenna 40 starts to receive all the TV broadcasting, which is the first content, according to the instruction from the main-processor 10 (S12). The received radio signals of all the TV broadcasting are transmitted to the RF processing unit 38. The down converter included in the RF processing unit 38 performs down-converting process on the radio signals of all the TV broadcasting transmitted from the antenna 40, according to the instruction from the main-processor 10 (S14). More specifically, the converter demodulates high-frequency band signals to base band signals and performs a decoding process, such as error correction or the like. Further, the RF processing unit 38 transmits all the down-converted TV broadcasting wave signals to the ADC 36. Subsequently, the main-processor 10 starts the main memory 16 and the sub-processor 12 (S18). A detailed description will be given later.

According to the instruction from the main-processor 10, the ADC 36 converts all the TV broadcasting wave signals from analog to digital signals and transmits the signals to the main memory 16 via the first interface 18, the bus and the memory controller 14. The main memory 16 stores all the TV broadcasting data transmitted from the ADC 36. The stored TV broadcasting wave signals are to be used in an after-mentioned signal processing sequence in the sub-processor 12 (S26). A detailed description will be given later.

Further, the main-processor 10 requests all the net broadcasting data, which is the second content, from the network interface 26. The network interface 26 starts to receive all the net broadcasting (S20) and stores data in a buffer size specified by the main-processor 10, into the main memory 16. The main-processor 10 also requests the third content stored in the hard disk 28 from the hard disk 28. The third content is read out from the hard disk 28 (S22) and the read data, in a buffer size specified by the main-processor 10, is stored into the main memory 16. Further, the main-processor 10 requests the fourth content stored in the DVD driver 30, from the DVD driver 30. The DVD driver 30 reads the fourth contents (S24) and stores the data, in a buffer size specified by the main-processor 10, into the main memory 16.

In these process, the data requested from the network interface 26, the hard disk 28 and the DVD driver 30 and stored in the main memory 16 are only in an amount of the buffer size specified by the main-processor 10. Although the compression rate of source data is not fixed, a buffer size insured by codecs, such as MPEG2 or the like, is specified, generally. Thus, a size which satisfies the specified value is used. In the after-mentioned signal processing sequence in the sub-processor 12 or the like (S26), processing is performed one frame at a time and the processes of writing data and reading data are processed asynchronously. After one frame of data is processed, next frame of data is transmitted to the main memory 16 and the processing is repeated in a similar manner.

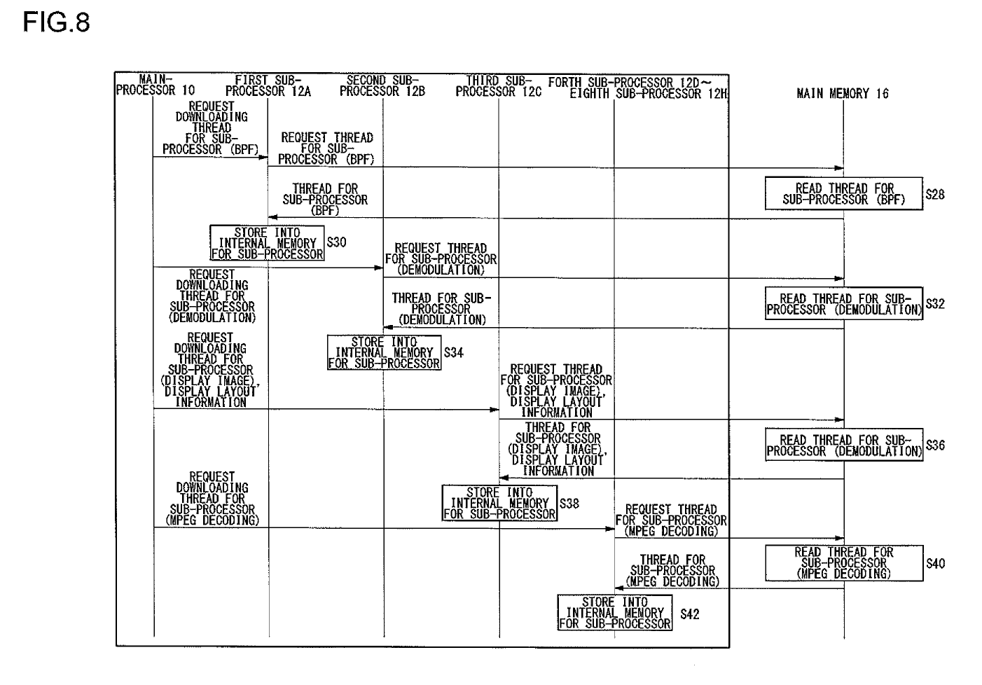

FIG. 8 shows an example of the starting sequence S18 shown in FIG. 7. Initially, the main-processor 10 transmits a request for downloading the first thread 62 to the first sub-processor 12A. Then, the first sub-processor 12A requests the first thread 62 from the main memory 16. The stored first thread 62 is read out from the main memory 16 (S28) and the first thread 62 is transmitted to the first sub-processor 12A. The first sub-processor 12A stores the downloaded first thread 62 into the internal memory 50 in the first sub-processor 12A (S30).

In a similar fashion, the main-processor 10 makes the second sub-processor 12B, the third sub-processor 12C, and the forth sub-processor 12D˜the eighth sub-processor 12H download a necessary thread from the main memory 16 according to a role assigned to respective processors. More specifically, the main-processor 10 requests the second sub-processor 12B to download the second thread 64 and requests the third sub-processor 12C to download the display layout information 58 and the third thread 65. Further, the main-processor 10 requests the forth sub-processor 12D˜the eighth sub-processor 12H to download the fourth thread 66. In any of the cases, respective sub-processors 12 store the downloaded thread into the respective internal memories 50 (S34, S38, S42).

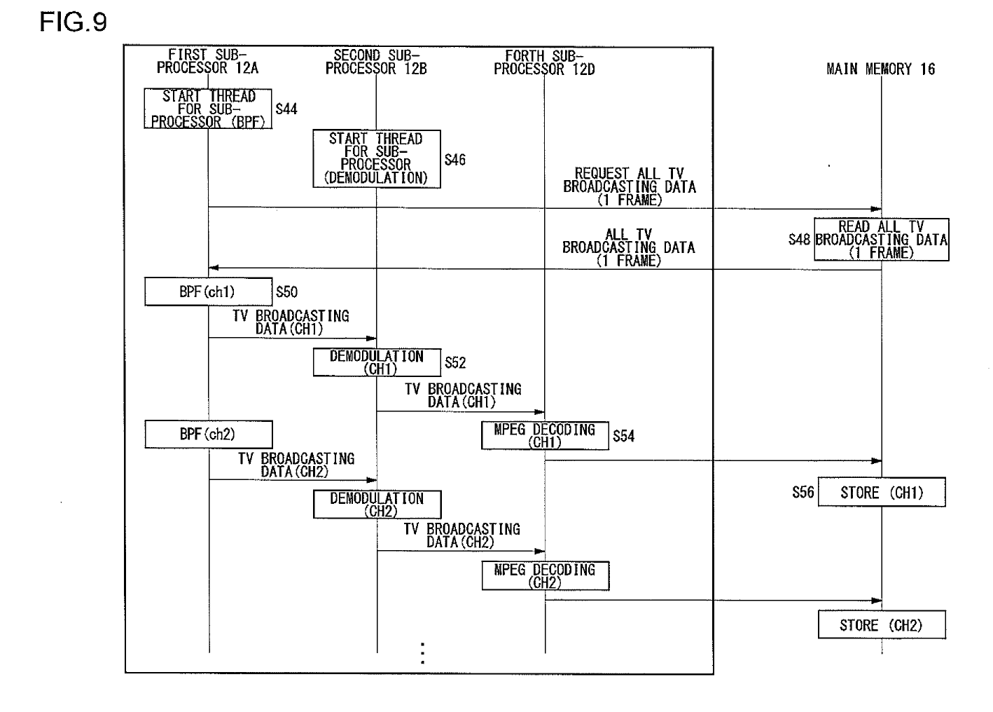

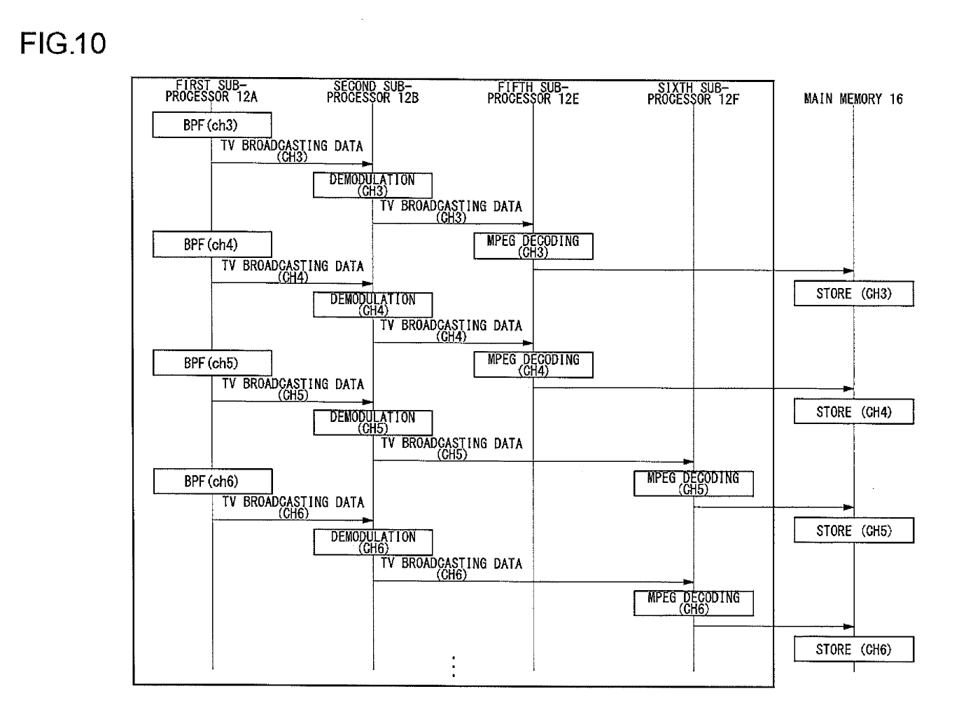

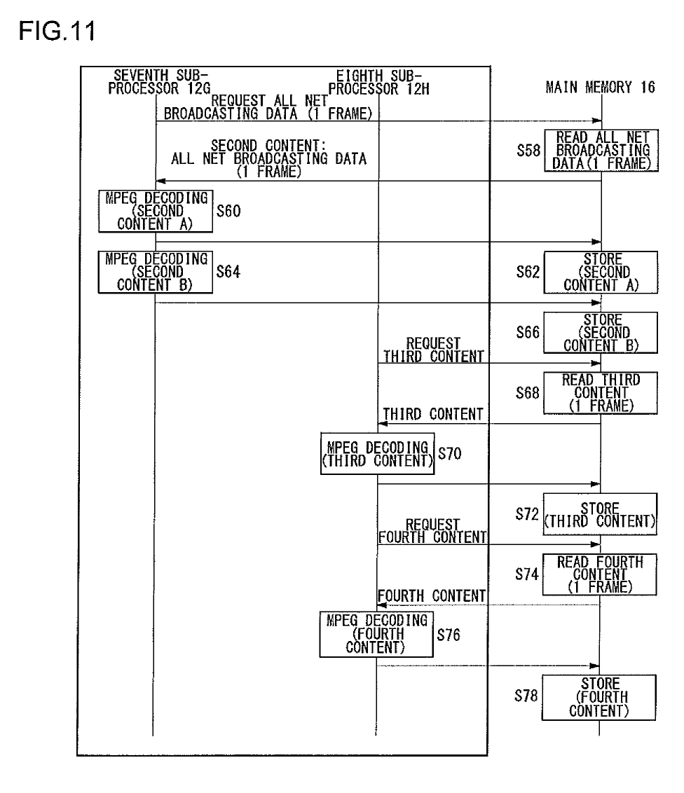

FIG. 9˜12 show examples of a detailed processing sequence of the signal processing sequence S26 shown in FIG. 7. Initially, a processing sequence for BPF process, demodulation process and MPEG decoding process of TV broadcasting data will be explained by way of FIG. 9 and FIG. 10. Then, BPF process, demodulation process and MPEG decoding process of net broadcasting data, DVD data and hard disk data will be explained by way of FIG. 11. Lastly, process of allowing the main memory 16 to display the image data, for which the variety of types of processing is completed, will be explained by way of FIG. 12.

FIG. 9 shows an example of a first processing sequence in the signal processing sequence shown in FIG. 7. In the first processing sequence, initially, the first sub-processor 12A starts the first thread 62 (S44), reads one frame of all the TV broadcasting data, which is the first content, from the main memory 16 (S48), performs BPF process on data of a first channel (S50) and pass the BPF-processed TV broadcasting data to the second sub-processor 12B. Subsequently, the second sub-processor 12B performs demodulation process on the BPF-processed TV broadcasting data (S52) and pass the data to the forth sub-processor 12D. Further, the forth sub-processor 12D performs MPEG decoding on the demodulated TV broadcasting data (S54) and stores the data into the main memory 16 (S56). As soon as the BPF process for the first channel completes, the first sub-processor 12A starts to perform BPF process for a second channel. Further, as soon as the demodulation process for the first channel completes, the second sub-processor 12B starts to perform demodulation process for the second channel. Furthermore, as soon as the MPEG decoding process for the first channel completes, the forth sub-processor 12D performs MPEG decoding process for the second channel. By performing pipeline processing in this way, images can be processed in high-speed.

FIG. 10 shows an example of a second processing sequence in the signal processing sequence S26 shown in FIG. 7. The first sub-processor 12A and the second sub-processor 12B perform BPF process and demodulation process on TV broadcasting data, which is the first content, for each channel, in a similar manner as the first processing sequence shown in FIG. 9. The third channel˜sixth channels are the channels to be processed here. The fifth sub-processor 12E and the sixth sub-processor 12F perform MPEG decoding process on two channels of data per sub-processor 12 and write the processed data into the main memory 16 respectively, in a similar manner as the case of the forth sub-processor 12D shown in FIG. 9. The first sub-processor 12A, the second sub-processor 12B, the fifth sub-processor 12E and the sixth sub-processor 12F perform pipeline processing in a similar manner as shown in FIG. 9, so as to speed up the image processing.

FIG. 11 shows an example of a third processing sequence in the signal processing sequence shown in FIG. 7. The seventh sub-processor 12G reads one frame of all the net broadcasting data stored in the main memory 16, as the second contents (S58). Two channels of all the net broadcasting data are to be read here, and are referred to as a second content A and a second content B, respectively. The seventh sub-processor 12G also performs MPEG decoding process on the second content A and the second content B, respectively (S60, S64) and stores the contents into the main memory 16 (S62, S66). Subsequently, the eighth sub-processor 12H reads the third content stored in the main memory 16 (S68), performs MPEG decoding on the content (S70) and stores the content into the main memory 16 (S72). In a similar fashion, the eighth sub-processor 12H reads the fourth content stored in the main memory 16 (S74), performs MPEG decoding on the content (S76), and stores the content into the main memory 16 (S78).

FIG. 12 shows an example of a fourth processing sequence in the signal processing sequence shown in FIG. 7. The third sub-processor 12C executes reading process of six channels of TV broadcasting data as the first content, two channels of net broadcasting data as the second content, the third content and the fourth content, stored in the main memory 16, sequentially (S80, S86). Every time the third sub-processor 12C reads one content, the sub-processor refers to a display size from the display layout information and performs image processing for producing a display effect on the image. The display effect here represents, brightening an image displayed on the intersection 76 shown in FIG. 5, increasing the color density of the image, making the image blink, or the like. Further, every time the third sub-processor 12C reads one content, the sub-processor calculates a write address based on the display layout information (S82, S88). Subsequently, the third sub-processor 12C performs process of writing the content data at the calculated address in the frame memory 21 (S84, S90). The content is displayed on the displaying unit 22 in accordance with the address position in the frame memory 21.

More specifically, the names of the contents are displayed in the media icon array 70, the horizontal bar of the cross-shaped array shown in FIG. 5, and specifics of the content in the content icon array 72, the vertical bar. The image to be displayed in the intersection 76, where the horizontal bar and the vertical bar cross, is displayed so as to produce a certain display effect by the third sub-processor 12C. In this manner, it is possible to provide images to be easily understood for a user viewing the displaying unit 22.

In this manner, the display screen image 200 shown in FIG. 5 can be displayed on the displaying unit 22. Further, by changing the display position of the respective frames, dynamic display effect can be produced. Furthermore, by changing the display size of the respective frames, dynamic display effect can be produced. In these cases, it is only necessary to define the display effect for the sub-processor 12, which processes the content to be displayed with the display effect, in the display layout information 58.

FIG. 13 shows an exemplary configuration of the main memory 16 shown in FIG. 1. The configuration of the main memory 16 shown in FIG. 13 represents the storage state of the main memory 16 after the sequence shown in FIG. 7. As shown in FIG. 13, the memory map of the main memory 16 may includes:

the application software 54,

one frame of a variety of content-data before BPF processing,

one I picture and P picture frame of a variety of content-data after MPEG decoding, and

three pre-display image storing areas as buffers for displaying images of a variety of contents on the displaying unit 22.

The reason to secure memory areas for “I picture and P picture referred to when MPEG decoding” for the image data of each content is as follows. MPEG data consists of an I picture, a P picture and a B picture. Among them, the P picture and the B picture can not be decoded alone and needs the I picture and/or the P picture for reference, found temporally before and after the picture, when being decoded. Therefore, even if decoding process for I picture and P picture is completed, the I picture and the P picture should not be discarded and need to be retained. Therefore, the memory areas for “I picture and P picture referred to when MPEG decoding” are areas for retaining those I pictures and P pictures. Pre-display image storing area 1 is a memory area for storing image data as RGB data at a stage preceding the writing into the frame memory 21 by the third sub-processor 12C, the RGB data having been subjected to BPF process, demodulation process and MPEG decoding process by the first sub-processor 12A, the second sub-processor 12B, the forth sub-processor 12D˜the eighth sub-processor 12H. In the pre-display image storing area 1, one frame of each of six channels of TV broadcasting data as the first content and one frame of each of the second content data˜the fourth content data are all included. A pre-display image storing area 2 and a pre-display image storing area 3 are configured in a similar fashion as the pre-display image storing area 1. The image storing areas are used circularly for each frame in the order: the pre-display image storing area 1→the pre-display image storing area 2→the pre-display image storing area 3→the pre-display image storing area 1→the pre-display image storing area 2→ . . . . The reason to need three pre-display image storing areas is as follows. When decoding MPEG data, a time required for the decoding varies depending on which of the I, P, B pictures is to be decoded. To make uniform and absorb the time variation as much as possible, it is required to provide three areas as memory areas for pre-display images.

According to the present embodiment, by defining a display effect and information indicating role assignment among sub-processors 12, image processing can be performed efficiently and images can be displayed on a screen with a desired display effect. Further, it is possible to provide a user with an easily-recognizable screen image. The embodiment may also be configured so that a thread in the main-processor 10 may operate in coordination with a thread in each sub-processor 12. By using the DMA method, data can be transmitted between the main memory 16 and a co-located unit or among co-located units while bypassing a CPU. The pipeline process enables high-speed image processing. By writing image data into the frame memory, the multi-core processor 11 can display an arbitrary moving image or a static image on the displaying unit 22. Further, a plurality of pieces of large image data, such as high definition image data or the like, can be processed in parallel simultaneously. Furthermore, since processing of tasks, such as demodulation processing or the like, are assigned in view of the remaining processing capacity of each of the plurality of processors, the system can reproduce contents efficiently. By sharing roles, a plurality of different contents, such as an image, a voice, or the like can be processed simultaneously and can be displayed or reproduced at a desired timing. Image data, processed by defining a display effect and/or a display position in advance, can be displayed on a display or the like as an image easily recognizable visually and reproduced as a voice easily recognizable aurally. Moreover, assigning roles to a plurality of processors for processing images, a plurality of contents can be processed efficiently with flexibility. In addition, an image processing apparatus which can process a plurality of contents efficiently can be provided.

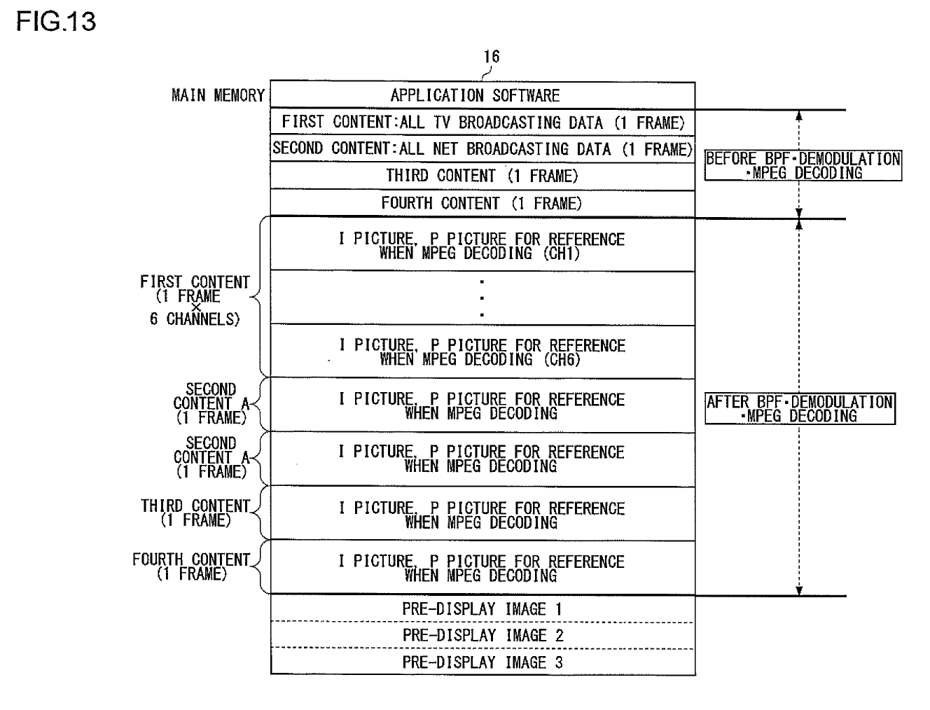

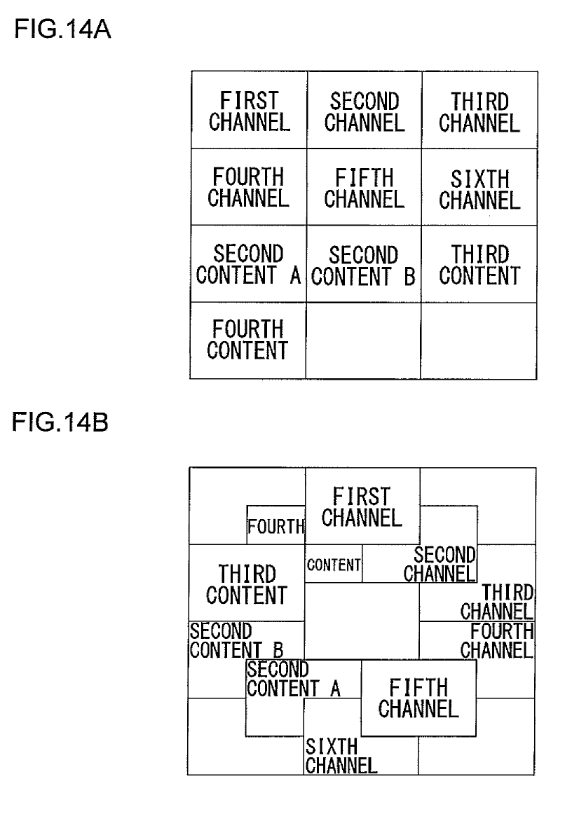

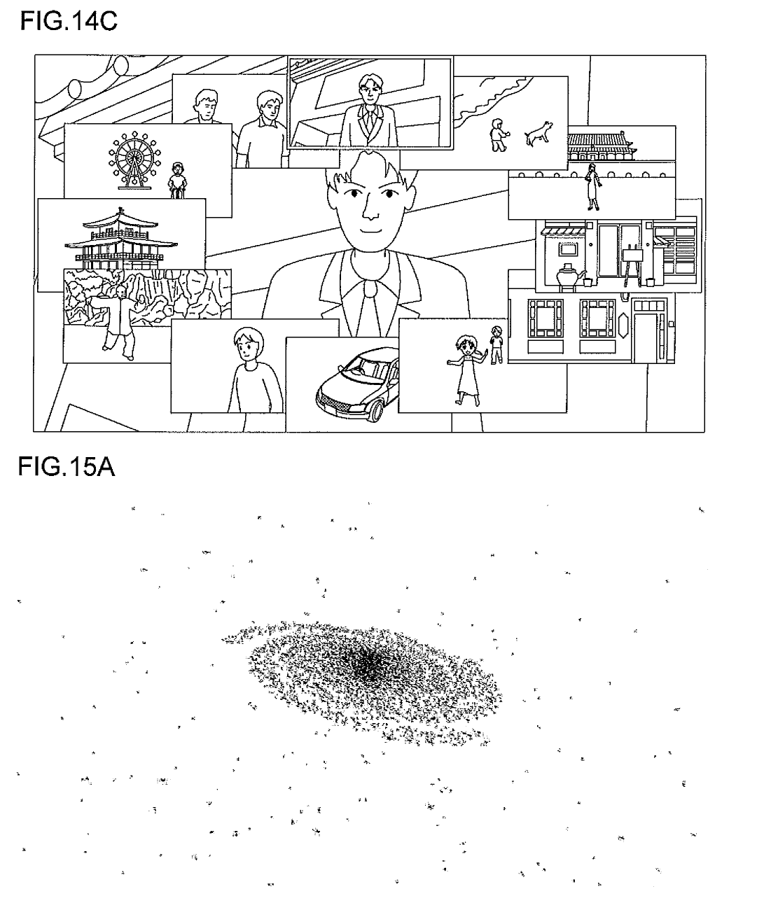

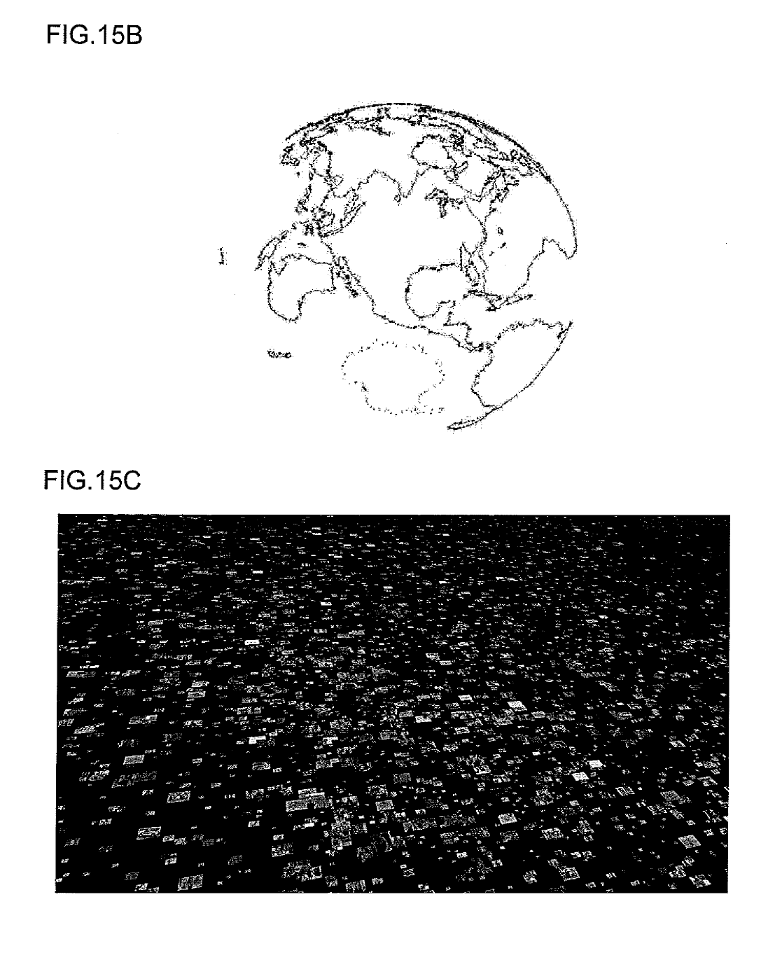

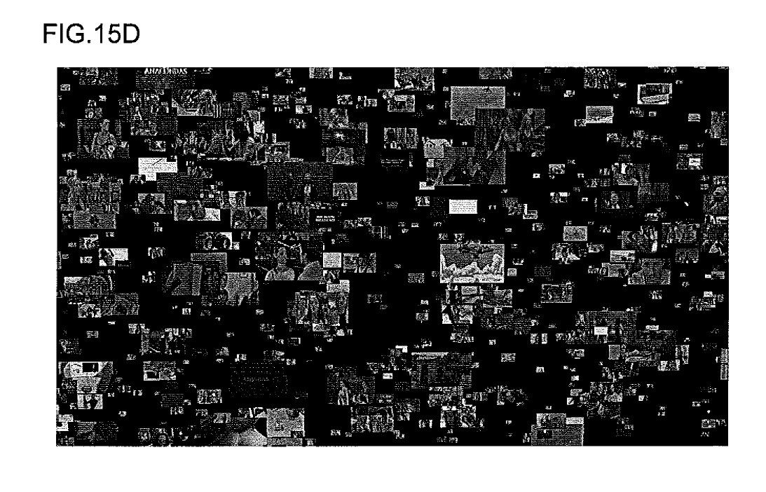

In the present embodiment, explanations are given in the foregoing, assuming that the contents are located and displayed in the cross-shaped array shown in FIG. 5. However, another layout as shown in FIG. 14A may be adopted. Alternatively, the contents may be arranged and displayed as shown in FIG. 14B, FIG. 14C, FIG. 15A, FIG. 15B, FIG. 15C and FIG. 15D, respectively. FIG. 14A, FIG. 14B and FIG. 14C show examples of a second to fourth display screen images, respectively, according to the present embodiment. FIG. 14A shows an example where respective contents are arranged in matrix form. FIG. 14B shows an example where respective contents are arranged and displayed approximately in circular form. FIG. 14C shows an example wherein a certain content is displayed as a background image and on the screen image, respective contents are arranged and displayed approximately in circular form, in a similar way as shown in FIG. 14B.

As described above, the third sub-processor 12C calculates the display size and the display position of each image using the pre-display image and the display layout information and writes into the frame memory 21, accordingly. To display the display screen image like the ones shown in FIG. 14A or FIG. 14B, it is only necessary to define the display position of the each image when setting the display layout information 58. The user is to manipulate the controller 34 and select a channel while watching the display screen image in FIG. 14A. Respective contents may be arranged and displayed approximately in circular form as shown in FIG. 14B. In FIG. 14C, the user may select an image corresponding to a content among the contents arranged approximately in circular form, by which the image can be displayed as a back ground image. Although in FIG. 10, the sixth sub-processor 12F performs MPEG decoding process for a fifth channel and a sixth channel, it is assumed here that a broadcast itself is not performed for the fifth channel and the sixth channel. “When a broadcast is not performed” represents, for example, a time during the midnight hours. In such a case, the sixth sub-processor 12F is generally set to non-operating mode. However, it is also possible to allow the sixth sub-processor 12F to perform other processing instead of the MPEG decoding process for the fifth channel and the sixth channel. Although all the net broadcasting data, to be read out in step S58 in FIG. 11, is assumed to consist of two channels of data in the foregoing, here, the net broadcasting data is assumed to include four channels of data. The newly added two channels of data are hereinafter referred to as a second content C and a second content D. Since it is impossible to perform MPEG decoding process of four channels by the seventh sub-processor 12G alone, the MPEG decoding process for the second content C and the second content D may be assigned to the sixth sub-processor 12F. Naturally, a user may determine whether or not a broadcast is performed for the fifth channel and the sixth channel and may switch the processing using the controller 34. Further, the determination may also be made using EPG information included in the TV broadcasting wave. That is, by analyzing the EPG information, a channel which is not broadcasted can be identified and a part or all of the processing capacity of a sub-processor, which has been performing BPF process, demodulation process, MPEG decoding process and displaying process of the channel, is assigned to another processing, by which effective operation can be implemented.

FIGS. 15A, 15B, 15C and 15D show photographs of an intermediate screen images which are examples of fifth, sixth, seventh and eighth screen image displayed on the display, respectively. FIG. 15A shows a photograph of an intermediate screen image of an exemplary screen image displayed on the display, wherein several tens of thousands of reduced-sized images are arranged in a form of the galaxy. FIG. 15B shows a photograph of an intermediate screen image of an exemplary screen image wherein images forming the shape of the earth, included in the images arranged and displayed in the form of the galaxy, are partly enlarged and displayed on the display. FIG. 15C shows a photograph of an intermediate screen image of an exemplary screen image wherein some of the images included in the images arranged and displayed in the form of the earth, are enlarged and displayed on the display. FIG. 15D shows a photograph of an intermediate screen image of an exemplary screen image wherein some of the images included in the images displayed as shown in FIG. 15C, are enlarged further and displayed on the display.

Although the user can not recognize individual images on the display screen in the state shown in FIG. 15A, it becomes possible to recognize the individual images as the images are enlarged in the order of FIG. 15B, FIG. 15C and FIG. 15D. When the user is able to recognize the individual images, for example, when the screen image of the state shown in FIG. 15D is displayed, the user may select any of the images using the controller 34 so that the selected image is enlarged and displayed. Enlarging process from FIG. 15A to FIG. 15D may be performed with the elapse of time. Alternatively, the images may be enlarged upon an instruction given by the user through the controller 34, as a trigger. The system may be configured so that the user can enlarge and display an arbitrary part of the screen image. In any of the cases, it is only necessary to define a display position and an image size in the display layout information 58 in advance. The management of time scheduling or the processing in response to the instruction from the user through the controller 34 maybe performed by the main-processor 10 or any of the sub-processors 12. Alternatively, the main-processor 10 and the sub-processor 12 control or process in cooperation with each other. Through this configuration, the screen images like the ones shown in FIG. 15A˜FIG. 15D can be displayed while changing them dynamically.

As another arrangement method, multi-images shown at the center on the displaying unit in a small size at first, may be enlarged and displayed in a large size so that the multi-images fill the entire screen of the displaying unit as time elapses. This produces an effect as if the multi-images are approaching from the back to the front of the screen. To produce the effect, it is just necessary to provide not mere two-dimensional coordinate data but also the entire coordinate data changing with the elapse of time, as the display layout information 58. Alternatively, a certain number of different parts may be selected from one content (e.g., a movie stored in a DVD) and may be displayed in multi-image mode. This enables to provide an index with moving images by reading and displaying, for example, ten parts of image data from a two-hour movie. Thus a user can find a part he/she would like to watch immediately and start playing that part, accordingly.

The present invention may also be implemented by way of items described below.

### (Item 1)

A plurality of sub-processors may include at least first to fourth sub-processors. The first sub-processor may perform band pass filtering process on data provided from a data providing unit. The second sub-processor may perform demodulation process on the band-pass-filtered data. The third sub-processor may perform MPEG decoding process on the demodulated data. The fourth sub-processor may perform image processing, for producing a display effect, on the MPEG-decoded data and may display the image at a display position.

### (Item 2)

A main-processor may monitor the elapse of time and notify a plurality of processors and the plurality of sub-processors may change an image, displayed on the display apparatus, with the elapse of time. Further, information, indicating that the display position changes with the elapse of time, may be set in an application software.

### (Item 3)

Information, indicating that the display size of an image changes with the elapse of time, may be set in an application software. Information indicating that the color or the color strength of the image changes with the elapse of time may also be set as a display effect.

### (Item 4)

After a plurality of sub-processors process image data provided from a data providing unit sequentially, based on information indicating role assignment and information indicating a display effect, designated by application software, a display controller may display the processed image at a display position on a display apparatus.

According to the aforementioned items, the application software assigns roles to the plurality of sub-processors and allows the processors to perform image processing, by which a plurality of contents can be processed efficiently with flexibility.

The “data on image” may include not only image data, but also voice data, data rate information and/or encoding method of image/voice data, or the like. The “application software” represents a program to achieve a certain object and here includes at least a description on display mode of an image in relation with a plurality of processors. The “application software” may include header information, information indicating a display position, information indicating a display effect, a program for a main-processor, executing procedure of the program, a program for a sub-processor, executing procedure of the program, other data, or the like. The “data providing unit” represents for example, a memory which stores, retains or reads data according to an instruction. Alternatively, the “data providing unit” may be an apparatus which provides television image or other contents by radio/wired signals. The “display controller” may be, for example:

a graphics processor which processes images in a predetermined manner and outputs the image to a display apparatus, or

a control apparatus which controls input/output operation between the display apparatus and the sub-processor. Alternatively, one of the plurality of sub-processors may play a role as the display controller.

The “role sharing” represents, for example, assigning time to start processing, processing details, processing procedures, to-be-processed items or the like to respective sub-processors, depending on the processing capacity or the remaining processing capacity of the respective sub-processors. Each sub-processor may report the processing capacity and/or the remaining processing capacity of the sub-processor to the main-processor. The “display effect” represents, for example:

an effect where voice is reproduced along with an image when the image is displayed,

an effect where image/voice changes with the elapse of time,

an effect where image/voice changes, an image is emphasized or the sound volume is changed based on the instruction of the user, or the like.

The “color strength” represents color density, color brightness or the like. That “color strength of the image changes” represents, e.g., that the density or brightness of the color of the image changes, the image blinks, or the like.

Given above is an explanation based on the exemplary embodiments. These embodiments are intended to be illustrative only and it will be obvious to those skilled in the art that various modifications to constituting elements and processes could be developed and that such modifications are also within the scope of the present invention.

1-7. (canceled)

8. An image processing system comprising:
a plurality of sub-processors operative to process data on image in a predetermined manner;
a main-processor, connected to the plurality of sub-processors via a bus, operative to execute a predetermined application software and to control the plurality of sub-processors;
a data providing unit operative to provide the data on image for the main-processor and the plurality of sub-processors via the bus; and
a display controller operative to perform processing for outputting an image processed by the plurality of sub-processors to a display apparatus, wherein
the application software is described so as to include
information indicating respective roles assigned to the respective plurality of sub-processors and
information indicating the display position of respective images processed by the plurality of sub-processors on the display apparatus; and
according to the information indicating respective roles assigned by the application software and information indicating the display position, the plurality of sub-processors in a timely manner process the data on the image provided from the data providing unit and display the processed image at the display position on the display apparatus.

9. The image processing system according to the claim 8, wherein
the application software is described so as to further include information indicating the display effect of respective images being processed by the plurality of processors, and
the plurality of sub-processors also comply with the information indicating the display effect when processing the data on image provided from the data providing unit in a timely manner.

10. The image processing system according to the claim 9, wherein
as the display effect described by the application software, is defined such that the color of the image or the strength of the color of the image changes with an elapse of time.

11. The image processing system according to the claim 8, wherein
display positions of respective images are determined so that
a plurality of media images corresponding to respective media are displayed in the horizontal direction on the display apparatus, and
a plurality of images belonging to the selected media are displayed in the vertical direction on the display apparatus.

12. The image processing system according to the claim 8, wherein
display positions of respective images are defined so that an aggregate of respective images displayed on the display apparatus forms a shape of a predetermined object as a whole.

13. The image processing system according to the claim 8, wherein
the plurality of sub-processors include:
a first sub-processor operative to perform band-pass-filtering process on the data provided from the data providing unit;
a second sub-processor operative to perform demodulation process on the band-pass-filtered data; and
a third sub-processor operative to perform MPEG decoding process on the demodulated data.

14. The image processing system according to the claim 8, wherein:
the main-processor monitors an elapse of time and notify the plurality of sub-processors; and
the plurality of sub-processors change an image to be displayed on the display apparatus with the elapse of time.

15. The image processing system according to the claim 8, wherein
the application software is described so that information, indicating that the display position changes with an elapse of time, is defined.

16. The image processing system according to the claim 8, wherein
the application software is described so that information, indicating that the display size changes with an elapse of time, is defined.
